(19) United States
(12) Patent Application Publication
(10) Pub. No.: US 2010/0163589 A1
(43) Pub. Date: Jul. 1, 2010

(54) Bicycle lock box

(76) Inventors: Kenneth Kwak, Venice, CA (US); Eric Darnas, Manna del Rey, CA (US)

Correspondence Address: TROJAN LAW OFFICES, 9250 WILSHIRE BLVD, SUITE 325, BEVERLY HILLS, CA, 90212, US

(21) Appl. No.: 12/319,066

(22) Filed: Dec. 30, 2008

(51) Int. Cl. B62J 9/00

(52) U.S. Cl. 224/435; 220/315; 220/751; 206/223; 224/418

(57) ABSTRACT

A storage device having a lockable container for securely storing small items, attaches to the support frame of a bicycle, and further serves as a holder for a U-shaped bicycle lock. According to a preferred embodiment, the bicycle attachment element is lockable and attachable to the bicycle frame only when the container is in an open position. Once the lock box is locked, it cannot be removed from the bicycle frame.

### BACKGROUND

1. Field of the Invention

The present invention generally relates to storage devices, and in particular, to portable storage devices used by cyclists.

2. Description of the Related Art

Cyclists often need to carry valuables, such as wallets, money, keys, and other items, while cycling. However, carrying such items, e.g. in a pocket or bag, while cycling is often inconvenient and/or uncomfortable. Sometimes, the bicycle frame is utilized as a convenient means for attaching various items which need to be transported, including storage containers for small items. Additionally, a bicycle lock is a standard item which is also attached to the frame during transport. However, as a rider desires to minimize the bulk and number of items carried on the frame, and may also desire to leave the items with the bicycle unattended, it is advantageous to find an improved device and method for conveniently transporting items wile cycling, and for securely storing these items with an unattended bicycle.

### SUMMARY

The present invention provides a storage device having a lockable container, and bicycle attachment element which attaches to the support frame of a bicycle. Additionally, the device serves as a holder for a U-shaped bicycle lock. The device allows a user to securely store small items such as keys, a wallet, or other valuables, in the container while leaving the bicycle unattended (i.e. locked to a bicycle rack), and further can conveniently hold the bicycle lock during transportation. According to a preferred embodiment, the bicycle attachment element is lockable and attachable to the bicycle frame only when the container is in an open position. Once the lock box is locked, it cannot be removed from the bicycle frame.

### BRIEF DESCRIPTION OF THE DRAWINGS

FIG. 1 is a perspective view of a storage device, in accordance with an embodiment of the present invention, illustrated with the cover opened.

FIG. 2 is a perspective view of a common U-shaped bicycle lock, commonly known as a Kryptonite® brand lock.

FIG. 3 is a front perspective view of the device of FIG. 1, with the lock of FIG. 2 held around the device. The device is illustrated with the cover closed.

FIG. 3a illustrates an alternate embodiment for the container of FIG. 3, wherein the container has a downwardly curved bottom wall which conforms to the boundaries of the lock.

FIG. 4 is a top side perspective view of the device of FIGS. 1, shown with the lock held by the device, and with the cover opened.

FIG. 5 illustrates the device of FIG. 1 attached to a bicycle.

FIG. 6 is a perspective view of a storage device, in accordance with an alternate embodiment of the invention. The device is illustrated with the cover opened, and without the lock.

FIG. 7 is a perspective back view of the embodiment shown in FIG. 6.

### DETAILED DESCRIPTION

The detailed description set forth below is intended as a description of an exemplary embodiment and is not intended to represent the only forms in which the exemplary embodiment may be constructed and/or utilized. The description sets forth the functions and the sequence of steps for constructing and/or operating the exemplary embodiment. However, it is to be understood that the same or equivalent functions and sequences may be accomplished by different exemplary methods are also intended to be encompassed within the spirit and scope of the invention.

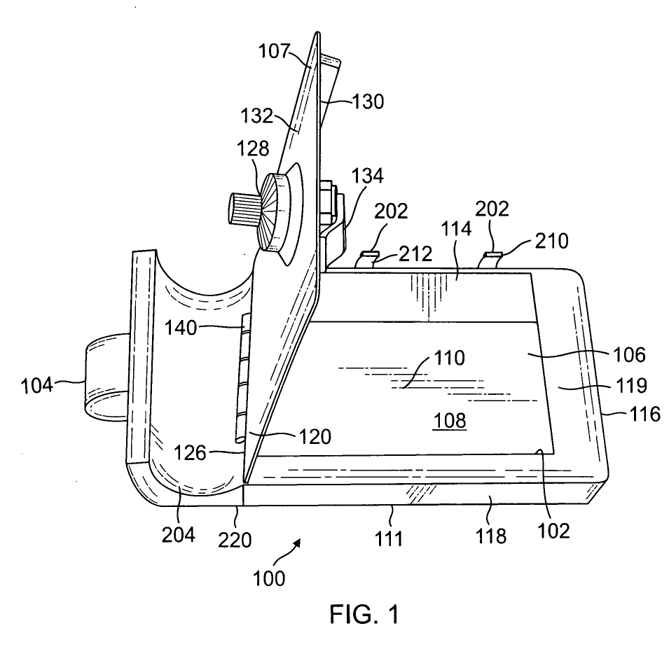

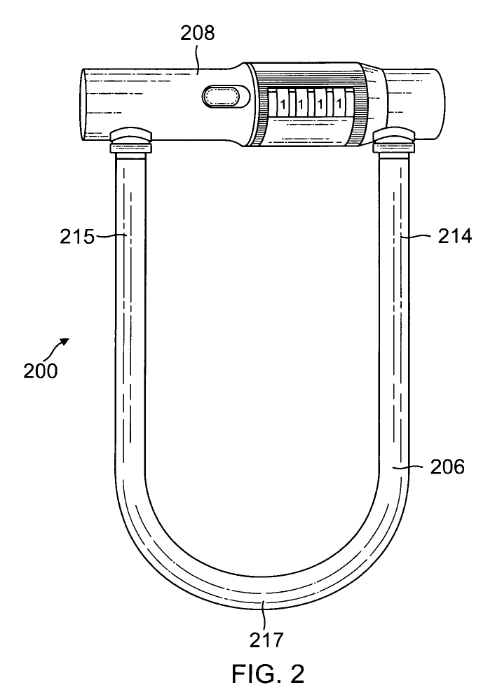

Illustrated in FIG. 1 is a storage device 100 including a lockable container 102, in accordance with a preferred embodiment of the invention. The device 100 further includes a bicycle attachment element 104, for attachment of the device 100 to the frame of a bicycle, and retaining members 202 and 204, for retaining a U-shaped bicycle lock 200, such as the commonly known Kryptonite® brand lock (see FIG. 2).

The container 102, includes a storage portion 106, and cover 107. The storage portion 106 comprises a flat rectangular back panel 108, having opposite inner and outer sides with surfaces surface 110 and 111, and side walls 114, 116, 118, and 120, extending perpendicularly from the inner side of the panel 108 to form storage portion 106.

The cover 107, comprises a flat panel having inner and outer opposite sides, 130 and 132, respectively, and is hinged to the top portion 126 of wall 120 via a hinge element 140. The cover further includes a combination lock 128. The lock 128 includes a combination pad on the outer side 132 of the cover, and latch 134 on the inner side 130, which engages a top extension panel 119 of the wall 116, when the box is locked.

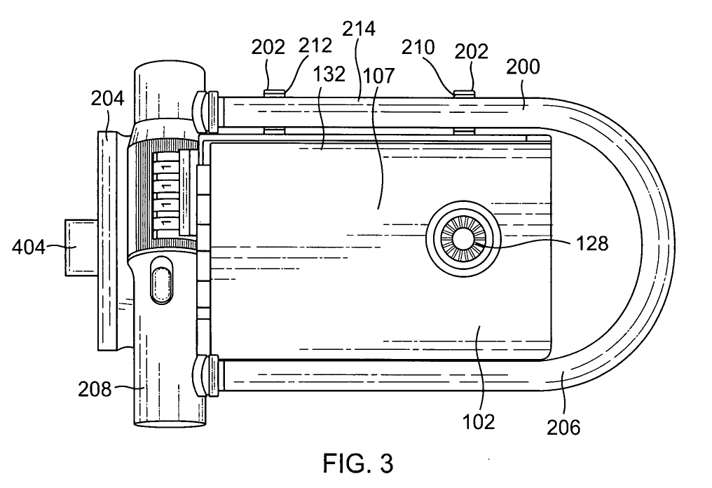

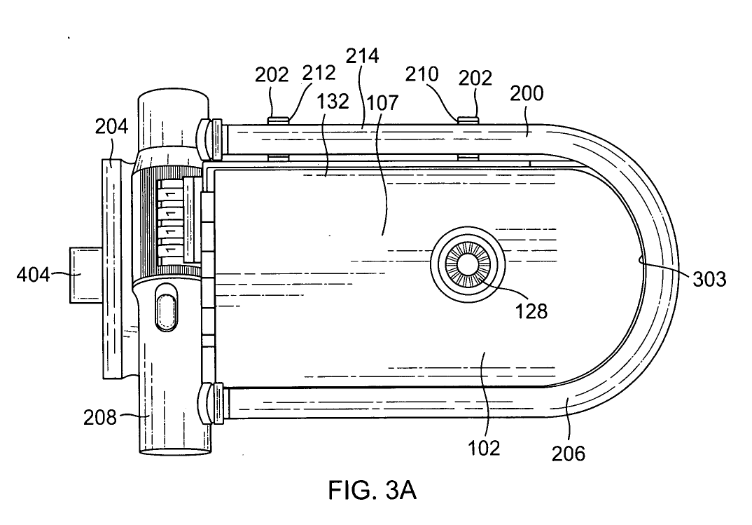

The outer sides of walls 114 and 120 further include holding elements comprising retaining members 202 and 204, for engaging a standard bicycle lock, such as a Kryptonite® lock 200, as shown in FIG. 3. The lock 200, shown in FIG. 2, includes a U-shaped portion 206, having an open top end, opposing first and second straight side segments 214 and 215, with a bottom arc 217 extending downwardly from and between the side segments, and a cylindrical locking bar 208 across the top of the U.

It should be understood that the geometric shape or design of the container may vary, without departing from the scope of the present invention. For example, the container may include a geometric configuration having a downwardly curved bottom wall 303 instead of the straight wall, as illustrated in FIG. 3a. The design of FIG. 3a maximizes the surface area of 20 the container, within the boundaries of the Kryptonite® lock. Alternatively, the bottom wall 303 may be upwardly curved to create a circular space between the lock and wall, which may be suitable for a cylindrical container such as a water bottle or can. Preferably, the geometric configuration of the container comprises at least four sides, which may include straight walls or one or more curved walls (as a curved wall has infinite sides). Other configurations will be apparent to one skilled in the art.

Referring back to FIG. 3, holding element comprising first and second retaining members, 202 and 204, capable of receiving and releasably clasping the side segments and top locking bar, respectively. First retaining member 202 includes two generally semi-circular segments 210 and 212 for retaining one of the straight segments (e.g. 214) of the portion 206, on one side of the U. Additionally, second retaining member 204 comprises a generally semi-circular tubular member approximately spanning the width of the container 102, and having a back panel 220 which is an integral extension of panel 108. Thus, retaining member 204 engages a relatively larger portion of the locking bar 208 as compared to the section engaged by retaining member 202. The lock 200 snaps into retaining members 202 and 204, and is held in place around the container 102.

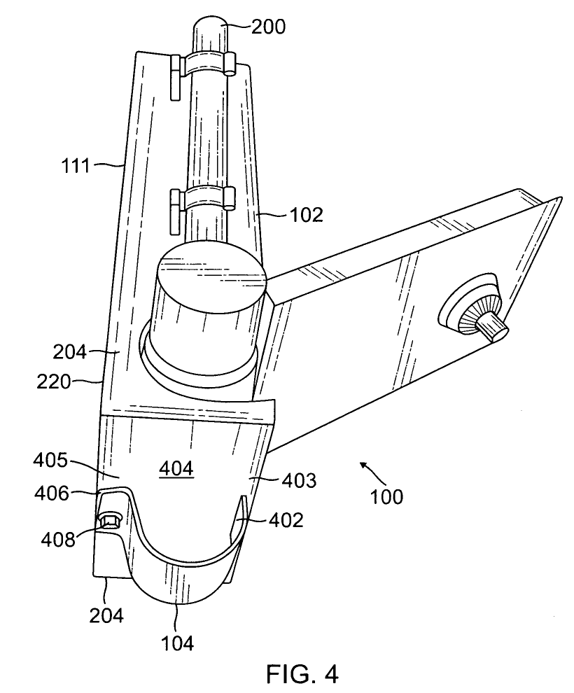

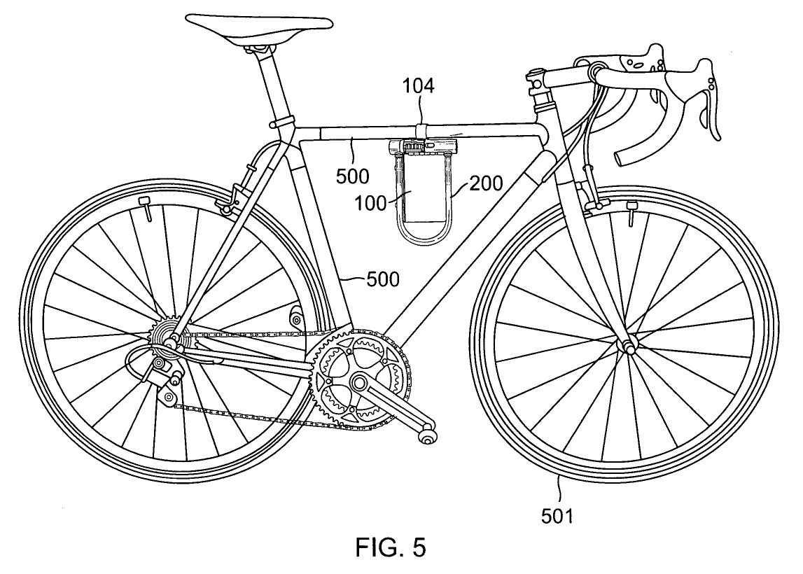

With specific reference to FIG. 4, attachment element 104 comprises a band having a first leg 402 firmly affixed to around a frontal section 403 of an outer side panel 404 of retaining member 204, and a second leg 406, affixed around a posterior section 405 of panel 404, forming an arc protruding from panel 404. The second leg 406 is held in place by a bolt 20 or screw 408, which can be removed for creating an opening between panel 404 and attachment element 104, such that element 104 can be wrapped around the support frame 500 of a bicycle 501 for attaching device 100, as illustrated in FIG. 5. Once element 104 is wrapped around the frame, the screw 408 is replaced and tightened to firmly attach the device. The device 100 can thus be attached to the vertical, diagonal, or horizontal section of the frame 500. In this embodiment, a flexible rigid material such as metal or plastic is most suitable for the manufacture of the band of element 104.

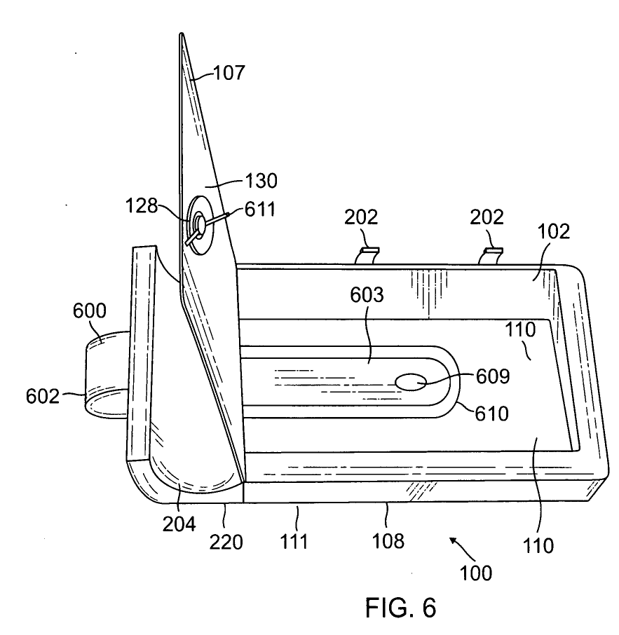

According to an alternate embodiment, shown in FIG. 6, the device 100 includes an attachment element 600, which is lockable and attachable to the bicycle frame only when the container 102 is in an open position. Once the lock box is locked, the element 600 can also be locked into place such that it cannot be removed from the bicycle frame.

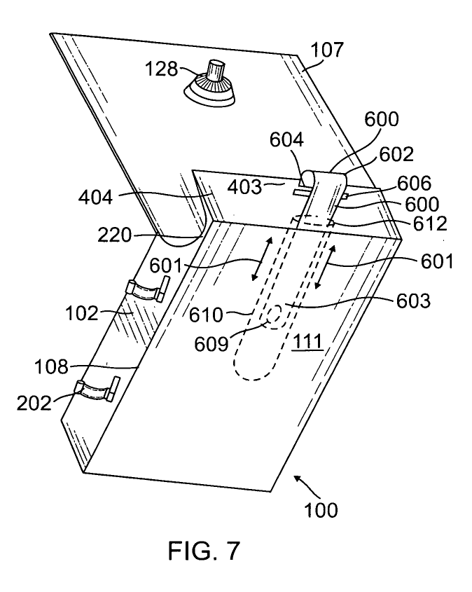

As illustrated in the FIGS. 6 and 7, attachment element 600 is a band having a top arc portion 602, and a tongue 603 which extends from the arc into the container 102 through panels 220 and 108 of holding element 204 and container 102 respectively. Element 600 is slidable up and down (indicated by arrow 601) between an open position (shown in FIG. 7), which provides clearance space between the arc 602 and panel 404 for affixing the device 100 to the bicycle frame, and a closed position which securely locks the element to the frame. The Arc 602 has a leg or edge 604 which abuts top section 403 of the outer side panel 404 in the closed position. The edge 604 is not affixed to the panel 404, but rather either rests against it, or inserts into a slot or trench 606 provided on the panel 404.

Tongue 603 includes a hole 609 which locks element 600 in place by insertion of a locking latch such as rod 611 extending from the inner side 130 of the cover 107. Thereby, element 600 can be affixed by closing the cover 107 with rod 611 engaged within the hole 609. Although rod 611 is shown extending from the lock 128, it may extend from any location on the cover. Other varied mechanisms for locking tongue 603 in place when the cover 107 is in closed position will be obvious to one skilled in the art, and are within the intended scope of this invention.

Preferably, a recessed track 610 extends from an insertion slot 612, provided on panel 404, through panels 220 and 108, allowing the tongue 603 to slide up and down on the track. The track is embedded through the panels, and may be entrenched and fully exposed through surface 110 of panel 108, or mostly embedded within both panels, as long as at least a section exposing the hole 609 of the tongue is exposed, such that it may be lockably engaged via rod 611 when the element 600 is in the closed position.

Similar to attachment element 104, attachment element 600 is preferably made of a rigid material, such as metal or plastic.

It should further be understood that the holding and attachment elements may vary in width and placement around the container. Additionally, the container cover may be hinged or otherwise connected at any of the walls, or may be unconnected, such that it is entirely removable when the box is opened, but still lockable. Additionally, other types of locking mechanisms, such as a key lock, are within the scope of the invention. The device 100 is preferably made of metal, but may also be made of other suitable rigid materials such as plastic, composites, etc.

In closing, it is to be understood that the exemplary embodiment described herein are illustrative of the principles of the present invention. Other modifications that may be employed are within the scope of the invention. Thus, by way of example, but not of limitation, alternative configurations may be utilized in accordance with the teachings herein. Accordingly, the description is illustrative and not meant to be a limitation thereof.

What is claimed is:

1. A storage device comprising:
a) a lockable container including:
i) a storage portion, comprising:
a flat back panel including inner and outer opposite faces, and at least four sides forming a perimeter of a first geometric configuration, and
surrounding walls, each having first and second opposing edges, wherein said first edge of each surrounding wall adjoins one of said sides of said back panel, and extends perpendicularly and forwardly from said inner side of said back panel to form said storage portion, wherein
said storage portion fits within a U-shaped bicycle lock, said bicycle lock comprising:
a U-Shaped portion having an open top end, opposing first and second straight side segments and a bottom arc extending downwardly from and between said straight side segments, opposite said open top end, and
a top locking bar across the open top end of the U-shaped portion, wherein
said surrounding walls of said storage portion comprise a top surrounding wall and first and second opposite side surrounding walls, generally perpendicular to said top surrounding wall, such that when said storage portion is fitted within said bicycle lock, said top surrounding wall is adjacent to said top locking bar, and said first and second side surrounding walls are adjacent to said first and second straight side segments of said U-shaped portion of said lock,
ii) a front cover hingedly affixed to the second edge of one of said surrounding walls of said storage portion, for opening and closing said container, said cover comprising:
a flat panel having a geometric configuration corresponding to said first geometric configuration of said back panel, and inner and outer opposite faces, wherein said inner face of said cover faces said inner face of said back panel,
a combination lock comprising a dial pad on said outer face of said cover, and a latch on said inner face of said cover, said combination lock being operable between open and locked positions, said latch adapted for lockably engaging said storage portion with said cover, when said combination lock is in said locked position;
b) holding elements for retaining said U-shaped bicycle lock, said holding elements comprising:
i) a first retaining member coupled to an outer side of at least one of said side surrounding walls of said storage portion, said first retaining member capable of receiving and releasably clasping at least one of said straight side segments of said U-shaped portion of said lock, and
ii) a second retaining member having top and bottom opposite sides, said bottom side of said second retaining member being coupled to an outer side of said top surrounding wall of said storage portion, said second retaining member having a back panel adjacent said back panel of said storage portion, said retaining member capable of receiving and releasably clasping said locking bar of said lock; and
c) a bicycle attachment element, coupled to said top side of said second retaining member, said attachment element being capable joining said device to a frame portion of a bicycle.

2. The storage device of claim 1, said bicycle lock being a Kryptonite® brand lock.

3. The storage device of claim 1, said attachment element comprising a continuous band having first and second bottom legs, which are generally affixed to said top side of said second retaining member, wherein at least one of said legs is affixed via a screw, said screw being removable for disjoining said leg from said top side, such that disjoining said leg provides an opening between said top side of said second retaining member and said attachment element for inserting said frame portion within said band, whereby said screw can be rejoined for affixing said device to said frame portion.

4. The storage device of claim 1, said attachment element comprising a continuous band having an arc and first and second bottom legs extending downwardly from opposite sides of the arc, said first bottom leg comprising a bottom edge abutting said top side of said second retaining member, and capable of changing between an open and closed position, wherein
said open position allows said bottom edge to be disjoined from said top side of said second retaining member, providing an opening between said top side and said attachment element for allowing said frame portion to be inserted within said band,
said closed position allows said bottom edge to be joined to said top side of said second retaining member, such that said device can be affixed around said frame portion, whereby said band wraps around said frame portion, and wherein
said closed position also allows said attachment element to be locked in place, by locking said cover.

5. The storage device of claim 4, said second bottom leg comprising a tongue extending downwardly from said arc into said container through said back panels of said second retaining member and said storage portion, wherein said attachment element is slidable between said open and closed positions.

6. The storage device of claim 5, said top side of said second retaining member comprising a slot for receiving said bottom edge of said first leg when said attachment element is in the closed position.

7. The device of claim 5, said tongue including a hole, said inner side of said front cover including a locking element capable of engaging said hole when said cover is closed, thereby preventing said attachment element from sliding.

8. The device of claim 7, said locking element comprising a rod.

9. The device of claim 5, said top side of said second retaining member comprising an insertion slot for receiving said tongue, and a recessed track extending from said insertion slot through said back panels of said second retaining member and said storage portion, whereby said attachment element is slidable on said track.

10. The device of claim 1, said first retaining member comprising two generally semi circular segments capable of wrapping around said straight side segments of said U-shaped portion of said bicycle lock, said second retaining member comprising a generally semi-circular tube element capable of wrapping around said locking bar of said bicycle lock.

11. A storage device comprising:
a) a lockable container including:
i) a storage portion, comprising surrounding side walls and top and bottom walls generally perpendicular to said surrounding side walls, wherein said storage portion fits within a U-shaped bicycle lock, said bicycle lock comprising:
a U-Shaped portion having an open top end, opposing first and second straight side segments and a bottom arc extending downwardly from and between said straight side segments, opposite said top end, and
a top locking bar across the open top end of the U-shaped portion, wherein
when said storage portion is fitted within said bicycle lock, said top wall of said storage portion is adjacent to said top locking bar, and said surrounding side walls of said storage portion are adjacent to said first and second straight side segments of said U-shaped portion of said lock
ii) a lockable cover capable of lockably closing and opening said storage portion, and further capable of forming an enclosed structure with said storage portion,
b) holding elements for retaining said U-shaped bicycle lock, said holding elements comprising:
i) a first retaining member coupled to an outer side of said surrounding side walls of said storage portion, said retaining member capable of receiving and releasably clasping at least one of said straight side segments of said U-shaped portion of said bicycle lock, and
ii) a second retaining member coupled to an outer side of said top wall of said storage portion, said retaining member capable of receiving and releasably clasping said locking bar of said bicycle lock; and
c) a bicycle attachment element, coupled to said second retaining member on a top side of said second retaining member, said top side being opposite said top wall of said storage portion, said attachment element capable of lockably attaching around a frame portion of a bicycle.

12. The storage device of claim 11, said bicycle lock being a Kryptonite® brand lock.

13. The storage device of claim 11, said attachment element comprising a continuous band having first and second bottom legs, which are generally affixed to said top side of said second retaining member, wherein at least one of said legs is affixed via a screw, said screw being removable for disjoining said leg from said top side, such that disjoining said leg provides an opening between said top side of said second retaining member and said attachment element for inserting said frame portion within said band, whereby said screw can be rejoined for affixing said device to said frame portion.

14. The storage device of claim 11, said attachment element comprising a continuous band having an arc and first and second bottom legs extending downwardly from opposite sides of the arc, said first bottom leg comprising a bottom edge abutting said top side of said second retaining member, and capable of changing between an open and closed position, wherein
said open position allows said bottom edge to be disjoined from said top side of said second retaining member, providing an opening between said top side and said attachment element for allowing said frame portion to be inserted within said band,
said closed position allows said bottom edge to be joined to said top side of said second retaining member, such that said device can be affixed around said frame portion, whereby said band wraps around said frame portion, and wherein
said closed position also allows said attachment element to be locked in place, by locking said cover.

15. The storage device of claim 14, said second bottom leg comprising a tongue extending downwardly from said arc into said container through said second retaining member and said storage portion, wherein said attachment element is slidable between said open and closed positions.

16. The storage device of claim 15, said top side of said second retaining member comprising a slot for receiving said bottom edge of said first leg when said attachment element is in the closed position.

17. The device of claim 15, said tongue including a hole and said cover including a locking element capable of engaging said hole when said cover is closed, thereby preventing said attachment element from sliding.

18. The device of claim 15, said top side of said second retaining member comprising an insertion slot for receiving said tongue, and a recessed track extending from said insertion slot through said second retaining member and said storage portion, whereby said attachment element is slidable on said track.

19. The device of claim 11, said first retaining member comprising two generally semi circular segments capable of wrapping around said straight side segments of said U-shaped portion of said bicycle lock, said second retaining member comprising a generally semi-circular tube element capable of wrapping around said locking bar of said bicycle lock.

20. A storage device comprising:
a) a lockable container including:
i) a storage portion, comprising:
a flat back panel including inner and outer opposite faces, and at least four sides forming a perimeter of a first geometric configuration, and
surrounding walls, each having first and second opposing edges, with said first edge of each surrounding wall adjoins one of said sides of said back panel, and extends perpendicularly and forwardly from said inner side of said back panel to form said storage portion, wherein
said storage portion fits within a U-shaped bicycle lock, said bicycle lock comprising:
a U-Shaped portion having an open top end, opposing first and second straight side segments and a bottom arc extending downwardly from and between said straight side segments, opposite said top end, and
a top locking bar across the open top end of the U-shaped portion, wherein
said surrounding walls of said storage portion comprise a top surrounding wall and first and second opposite side surrounding walls, generally perpendicular to said top surrounding wall, such that when said storage portion is fitted within said bicycle lock, said top surrounding wall is adjacent to said top locking bar, and said first and second side surrounding walls are adjacent to said first and second straight side segments of said U-shaped portion of said lock
ii) a front cover hingedly affixed to the second edge of one of said surrounding walls of said storage portion, for opening and closing said container, said cover comprising:
a flat panel having a geometric configuration corresponding to said first geometric configuration of said back panel, and inner and outer opposite faces, wherein said inner face of said cover faces said inner face of said back panel,
a combination lock comprising a dial pad on said outer face of said cover, and a latch on said inner side of said cover, said latch adapted for lockably engaging said storage portion with said cover;
b) holding elements for retaining said U-shaped bicycle lock, said holding elements comprising:
i) a first retaining member comprising two semi circular retaining segments coupled to an outer side of at least one of said side surrounding walls of said storage portion, said retaining segments capable of receiving and releasably clasping at least one of said straight side segments of said U-shaped portion of said lock, and
ii) a second retaining member comprising a generally semi-circular tube element having top and bottom opposite sides, said bottom side of said retaining tube being coupled to an outer side of said top wall of said storage portion, said retaining member further comprising a back panel adjacent said back panel of said storage portion, said retaining member capable of receiving and releasably clasping said locking bar of said lock;
c) a bicycle attachment element, coupled to said top side of said second retaining member, for attachment of said device to a frame portion of a bicycle, said attachment element comprising a band forming an arc and having first and second bottom legs, wherein said first leg is firmly affixed to said top side of said second retaining member, and said second leg is affixed via a screw to said top side of said retaining member, said screw being removable for detaching said second leg and providing an opening between said band and said second retaining member through which said frame portion can be inserted into said band.
